(19) United States
(12) Patent Application Publication
(10) Pub. No.: US 2015/0128686 A1
(43) Pub. Date: May 14, 2015

(54) Hardness tester apparatus

(71) Applicants: Denis Gloede, Plainwell, MI (US); David John Archer, Rockton, IL (US)

(72) Inventors: Denis Gloede, Plainwell, MI (US); David John Archer, Rockton, IL (US)

(21) Appl. No.: 14/079,597

(22) Filed: Nov. 13, 2013

(51) Int. Cl. G01N 3/48

(52) U.S. Cl. CPC G01N 3/48
USPC 73/82

(57) ABSTRACT

A hardness tester apparatus is disclosed for testing the hardness of a roll of material. The apparatus includes a housing having a first portion which is held by an operator. A socket panel defines a socket and an impulse hammer is connected to a plug received by the socket such that when the operator strikes the roll of material with the impulse hammer, a signal is generated which is transmitted to the plug. A hardness information collecting device is electrically connected to the socket. A display is electrically connected to the hardness information collecting device for displaying a reading corresponding to the hardness of the roll of material.

### BACKGROUND OF THE INVENTION

1. Field of the Invention

The present invention relates to a hardness tester apparatus.

More specifically, the present invention relates to a hardness tester apparatus for testing the hardness of a roll of paper or the like.

2. Background Information

In the production and use of a wound roll of paper or the like, it is important that the hardness of the roll be measured. Such hardness measurement will enable the operator to determine amongst other things, the tension that was applied to the web during winding thereof. Such measurements are important particularly to the end user during for example rewinding of the roll to provide smaller rolls, during slitting of the roll into a number of smaller rolls and when such rolls are to be loaded into a printing machine or the like.

In the prior art, it is known to provide an apparatus for testing the hardness of wound rolls, such as paper rolls, which yields quantitative information which is reproducible from roll to roll and under various conditions of testing. The apparatus can be operated by simply striking the roll at a point where hardness is to be determined with a force variable between certain limits as determined by the operator using an impulse hammer. The apparatus includes an accelerometer mounted in a head of the impulse hammer associated with circuitry for producing signals relating to (a) the energy of the impact between the head of the impulse hammer and roll and (b) the peak deceleration of the head. Those signals are processed to produce a roll hardness measure, which can be correlated to a commonly used scale if desired, and which is repeatable irrespective of the force used by the operator to cause the impact.

The known hardness testers are heavy and bulky and do not operate for an extended period. Also, there is a need in the art for a hardness tester which is strong enough to resist damage if accidently dropped while providing the operator thereof with an easy link to a barcode reader and laptop while being of relatively light in weight and small in size for enabling ease of transportation.

Therefore, it is a primary feature of the present invention to provide a hardness tester apparatus that is lighter, stronger and more easily operated when compared with the prior art arrangements.

Another feature of the present invention is the provision of a hardness tester apparatus that is more compact than the prior art arrangements.

Another feature of the present invention is the provision of a hardness tester apparatus that will operate for longer than the prior art testers.

Other features and advantages of the present invention will be readily apparent to those skilled in the art by a consideration of the detailed description of a preferred embodiment of the present invention contained herein.

### SUMMARY OF THE INVENTION

The present invention relates to a hardness tester apparatus for testing the hardness of a roll of material. The apparatus includes a housing having a first portion which is configured such that the first portion is held by an operator of the hardness tester apparatus. The first portion has a first and a second end and defines a face which extends between the first and the second end of the first portion. A socket panel is defined by the first portion, the socket panel extending from the first end of the first portion. The socket panel defines a socket and a plug cooperates with the socket such that the plug is received within the socket. An impulse hammer is connected to the plug such that in use of the apparatus, when the operator strikes the roll of material with the impulse hammer, a signal is generated by the impulse hammer, the signal being transmitted to the plug. A hardness information collecting device is housed within the first portion of the housing and is electrically connected to the socket such that the hardness information collecting device receives the signal from the impulse hammer. The housing has a second portion which extends from the second end of the first portion. The second portion defines a display which is electrically connected to the hardness information collecting device such that in use of the hardness tester apparatus, the display displays a reading which corresponds with the hardness of the roll of material. Such reading is readable by the operator. An encasing boot surrounds the housing for protecting the collecting device in the event of the operator dropping the hardness tester apparatus. The boot also isolates the collecting device from electrical static that would otherwise interfere with the hardness information collected by the collecting device.

In a more specific embodiment of the present invention, the housing is fabricated from a plastics material.

Also, the first portion is of rectangular configuration.

The face of the first portion defines a key pad for entering details of the roll of material being tested for hardness.

Furthermore, the key pad includes a plurality of function keys for changing a function of the information collecting device.

Moreover, the socket panel includes a download cable jack for connecting the apparatus to a computer for permitting storage and analysis of information regarding a hardness of various rolls of material.

Additionally, the socket panel includes a barcode reader pen jack for connection to a barcode reader pen for permitting a reading of a barcode associated with the roll of material being tested.

The first portion of the housing includes a clip for securing the impulse hammer except when the impulse hammer is being used.

Also, the second portion of the housing is of generally circular configuration.

Moreover, the display includes a protective cover.

A high capacity electric battery is disposed within the housing for powering the hardness information collecting device, the key pad, function keys and the display panel.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view partially in section of a hardness tester apparatus according to the present invention; and

FIG. 2 is an enlarged view taken on the line 2-2 of FIG. 1.

Similar reference characters refer to similar parts throughout the various views of the drawings.

### DETAILED DESCRIPTION OF THE DRAWINGS

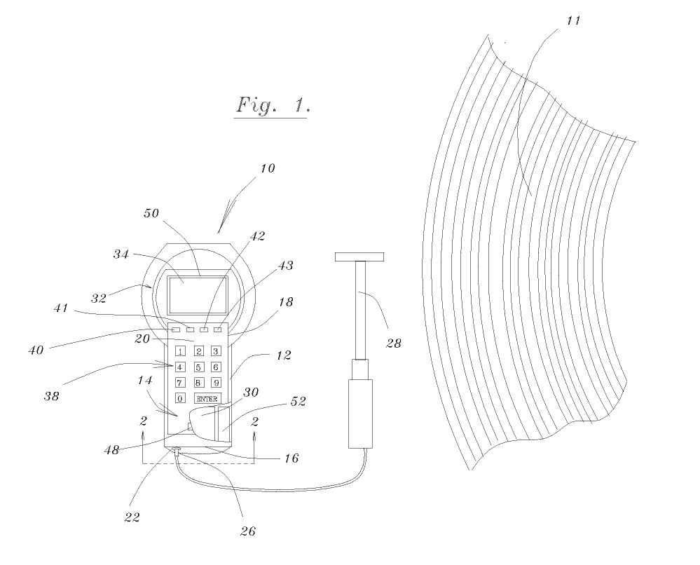

FIG. 1 is a side elevational view partially in section of a hardness tester apparatus generally designated 10 according to the present invention. As shown in FIG. 1, the hardness tester apparatus 10 is for testing the hardness of a roll of material such as a roll of paper 11. The apparatus 10 includes a housing generally designated 12 having a first portion generally designated 14 which is configured such that the first portion 14 is held by an operator of the hardness tester apparatus 10. The first portion 14 has a first and a second end 16 and 18 respectively and defines a face 20 which extends between the first end 16 and the second end 18 of the first portion 14. A socket panel generally designated 22 is defined by the first portion 14, the socket panel 22 extending from the first end 16 of the first portion 14.

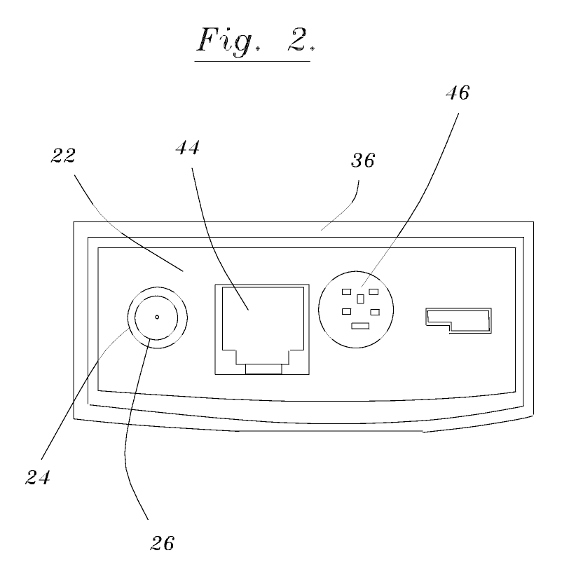

FIG. 2 is an enlarged view taken on the line 2-2 of FIG. 1. As shown in FIG. 2, the socket panel 22 defines a socket 24 and a plug 26 cooperates with the socket 24 such that the plug 26 is removably received within the socket 24.

As shown in FIG. 1, an impulse hammer 28 is connected to the plug 26 such that in use of the apparatus 10, when the operator strikes the roll of material 11 with the impulse hammer 28, a signal is generated by the impulse hammer 28, the signal being transmitted to the plug 26. A hardness information collecting device generally designated 30 is housed within the first portion 14 of the housing 12 and is electrically connected to the socket 24 shown in FIG. 2 such that the hardness information collecting device 30 receives the signal from the impulse hammer 28. The housing 12 has a second portion generally designated 32 which extends from the second end 18 of the first portion 14. The second portion 32 defines a display 34 which is electrically connected to the hardness information collecting device 30 such that in use of the hardness tester apparatus 10, the display 34 displays a reading which corresponds with the hardness of the roll of material 11. Such reading is readable by the operator.

As shown in FIG. 2, an encasing boot 36 surrounds the housing 12 for protecting the collecting device 30 in the event of the operator dropping the hardness tester apparatus 10. The boot 36 also isolates the collecting device 30 from electrical static that would otherwise interfere with the hardness information collected by the collecting device 30.

In a more specific embodiment of the present invention, the housing 12 is fabricated from a plastics material.

Also, as shown in FIG. 1, the first portion 14 is of generally rectangular configuration.

The face 20 of the first portion 14 defines a key pad generally designated 38 for entering details of the roll of material being tested for hardness.

Furthermore, the key pad 38 includes a plurality of function keys 40, 41, 42 and 43 for changing a function of the information collecting device 30.

Moreover, as shown in FIG. 2, the socket panel 22 includes a download cable jack 44 for connecting the apparatus 10 to a computer (not shown) for permitting the storage and analysis of information regarding a hardness of various rolls of material.

Additionally, the socket panel 22 includes a barcode reader pen jack 46 for connection to a barcode reader pen (not shown) for permitting a reading of a barcode associated with the roll of material being tested.

As shown in FIG. 1, the first portion 14 of the housing 12 includes a clip 48 for securing the impulse hammer 28 to the housing 12 except when the impulse hammer 28 is being used.

Also, the second portion 32 of the housing 12 is of generally circular configuration.

Moreover, the display 34 includes a protective cover 50.

A high capacity electric battery 52 is disposed within the housing 12 for powering the hardness information collecting device 30, the key pad 38, function keys 40-43 and the display 34.

In operation of the apparatus 10, the operator strikes the outer peripheral surface of the roll of paper 11 with the head of the impulse hammer 28. The impact of the head of the impulse hammer 28 with the surface of the roll 11 generates an impulse the magnitude of which is related to the hardness of the roll 11. One of the factors that contributes to the hardness of the roll 11 is the tension applied to the web of paper during the winding thereof into a roll. The impulse in the form of an electronic signal is transmitted from the impulse hammer 28 via the plug 26 and socket 24 to the hardness information collecting device 30 which includes an integrated circuit with various components for measuring and recording the magnitude of the signal. The details of the collecting device 30 are well known to those skilled in the art as exemplified in U.S. Pat. No. 5,079,728 to Adams et al. All of the disclosure of U.S. Pat. No. 5,079,728 to Adams et al. is incorporated herein by reference. Output from the collecting device 30 is received by the display 34 which gives a digital readout that corresponds with the hardness of the roll 11. If the operator is taking the hardness measurements of several rolls of paper each having an identifying barcode label thereon, the operator can plug in a barcode reader pen (not shown) into the jack 46 so that the identity of the roll 11 is taken and the corresponding hardness of that roll 11 is then measured by striking that roll 11 with the head of the impulse hammer 28. Furthermore, if a large number of rolls 11 are to be tested for hardness, a laptop computer or the like (not shown) can be connected to the hardness tester apparatus 10 via the download cable jack 44 so that the results from the tester apparatus 10 can be recorded, printed and analyzed as required.

If the roll 11 does not have a barcode label, the roll can be marked with for example an identifying number and this number can be entered into the tester apparatus 10 via the key pad 38 so that the subsequent hardness reading can be linked to the corresponding identifying number of the roll 11. The function keys 40-43 are provided so that if the hardness reading is to be measured for example by a different hardness measurement standard, the appropriate function key can be used which corresponds with required measurement scale or standard.

The apparatus 10 according to the present invention weighs in the region of 2 lb, has a battery life of 40 hours and a size of approximately 9″×5″×1.25″. A prior art tester known as BEL-2000 Profiler on the other hand has a weight of 6 lb, a battery life of 8-12 hours and a size of 12″×5″×2.75″.

The present invention provides a unique apparatus for testing the hardness of a roll of paper, the apparatus being light, compact and rugged while being easy to operate for an extended period of time.

What is claimed is:

1. A hardness tester apparatus for testing the hardness of roll of material, said apparatus comprising:
a housing having a first portion which is configured such that said first portion is held by an operator of the hardness tester apparatus, said first portion having a first and a second end;
said first portion defining a face which extends between said first and said second end of said first portion;
a socket panel defined by said first portion, said socket panel extending from said first end of said first portion;
said socket panel defining a socket;
a plug cooperating with said socket such that said plug is received within said socket;
an impulse hammer connected to said plug such that in use of the apparatus, when the operator strikes the roll of material with said impulse hammer, a signal is generated by said impulse hammer, said signal being transmitted to said plug;
a hardness information collecting device housed within said first portion of said housing, said hardness information collecting device being electrically connected to said socket such that said hardness information collecting device receives said signal from said impulse hammer;
said housing having a second portion extending from said second end of said first portion, said second portion defining a display which is electrically connected to said hardness information collecting device such that in use of the hardness tester apparatus, said display displays a reading which corresponds with the hardness of the roll of material such reading being readable by the operator; and
an encasing boot surrounding said housing for protecting said collecting device in the event of the operator dropping the hardness tester apparatus and for isolating said collecting device from electrical static that would otherwise interfere with said hardness information collected by said collecting device.

2. A hardness tester apparatus as set forth in claim 1 wherein
said housing is fabricated from a plastics material.

3. A hardness tester apparatus as set forth in claim 1 wherein
said first portion is of rectangular configuration.

4. A hardness tester apparatus as set forth in claim 1 wherein
said face of said first portion defines a key pad for entering details of the roll of material being tested for hardness.

5. A hardness tester apparatus as set forth in claim 4 wherein
said key pad includes:
a plurality of function keys for changing a function of said information collecting device.

6. A hardness tester apparatus as set forth in claim 1 wherein
said socket panel includes:
a download cable jack for connecting said apparatus to a computer for permitting storage and analysis of information regarding a hardness of various rolls of material.

7. A hardness tester apparatus as set forth in claim 1 wherein
said socket panel includes:
a barcode reader pen jack for connection to a barcode reader pen for permitting a reading of a barcode associated with the roll of material being tested.

8. A hardness tester apparatus as set forth in claim 1 wherein
said first portion of said housing includes:
a clip for securing said impulse hammer to said housing except when said impulse hammer is being used.

9. A hardness tester apparatus as set forth in claim 1 wherein
said second portion of said housing is of generally circular configuration.

10. A hardness tester apparatus as set forth in claim 1 wherein
said display includes:
a protective cover.

11. A hardness tester apparatus as set forth in claim 1 wherein
a high capacity electric battery is disposed within said housing for powering said hardness information collecting device, said key pad, function keys and said display panel.

12. A hardness tester apparatus for testing the hardness of roll of material, said apparatus comprising:
a housing having a first portion which is configured such that said first portion is held by an operator of the hardness tester apparatus, said first portion having a first and a second end;
said first portion defining a face which extends between said first and said second end of said first portion;
a socket panel defined by said first portion, said socket panel extending from said first end of said first portion;
said socket panel defining a socket;
a plug cooperating with said socket such that said plug is received within said socket;
an impulse hammer connected to said plug such that in use of the apparatus, when the operator strikes the roll of material with said impulse hammer, a signal is generated by said impulse hammer, said signal being transmitted to said plug;
a hardness information collecting device housed within said first portion of said housing, said hardness information collecting device being electrically connected to said socket such that said hardness information collecting device receives said signal from said impulse hammer;
said housing having a second portion extending from said second end of said first portion, said second portion defining a display which is electrically connected to said hardness information collecting device such that in use of the hardness tester apparatus, said display displays a reading which corresponds with the hardness of the roll of material such reading being readable by the operator;
an encasing boot surrounding said housing for protecting said collecting device in the event of the operator dropping the hardness tester apparatus and for isolating said collecting device from electrical static that would otherwise interfere with said hardness information collected by said collecting device; and
said housing being fabricated from a plastics material.

13. A hardness tester apparatus for testing the hardness of roll of material, said apparatus comprising:
a housing having a first portion which is configured such that said first portion is held by an operator of the hardness tester apparatus, said first portion having a first and a second end;
said first portion defining a face which extends between said first and said second end of said first portion;
a socket panel defined by said first portion, said socket panel extending from said first end of said first portion;
said socket panel defining a socket;
a plug cooperating with said socket such that said plug is received within said socket;
an impulse hammer connected to said plug such that in use of the apparatus, when the operator strikes the roll of material with said impulse hammer, a signal is generated by said impulse hammer, said signal being transmitted to said plug;
a hardness information collecting device housed within said first portion of said housing, said hardness information collecting device being electrically connected to said socket such that said hardness information collecting device receives said signal from said impulse hammer;
said housing having a second portion extending from said second end of said first portion, said second portion defining a display which is electrically connected to said hardness information collecting device such that in use of the hardness tester apparatus, said display displays a reading which corresponds with the hardness of the roll of material such reading being readable by the operator;
an encasing boot surrounding said housing for protecting said collecting device in the event of the operator dropping the hardness tester apparatus and for isolating said collecting device from electrical static that would otherwise interfere with said hardness information collected by said collecting device;
said housing being fabricated from a plastics material;
said first portion being of rectangular configuration;
said face of said first portion defining a key pad for entering details of the roll of material being tested for hardness;
said key pad including:
a plurality of function keys for changing a function of said information collecting device;
said socket panel including:
a download cable jack for connecting said apparatus to a computer for permitting storage and analysis of information regarding a hardness of various rolls of material;
a barcode reader pen jack for connection to a barcode reader pen for permitting a reading of a barcode associated with the roll of material being tested;
said first portion of said housing including:
a clip for securing said impulse hammer to said housing except when said impulse hammer is being used;
said second portion of said housing being of generally circular configuration;
said display including:
a protective cover; and
a high capacity electric battery being disposed within said housing for powering said hardness information collecting device, said key pad, function keys and said display panel.
